(19) United States
(12) Patent Application Publication
(10) Pub. No.: US 2007/0024009 A1
(43) Pub. Date: Feb. 1, 2007

(54) Gasket assembly

(76) Inventors: Gerald Rosenquist, Lake Zurich, IL (US); Gary Bold, Chicago, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/193,811

(22) Filed: Jul. 29, 2005

(51) Int. Cl. F02F 11/00

(52) U.S. Cl. 277/592

(57) ABSTRACT

The gasket assembly includes a gasket layer and a separately formed shim layer. The shim layer and gasket layer are formed with at least one media-conveying opening that correspond to media-conveying passages communicating between first and second members to be clamped together and sealed by the gasket at the joint between members. The shim layer has an adhesive layer applied to its back surface 36 to enable the shim layer 14 to be adhered to original clamping face of the one of the first or second members in order to build up the surface or to cover up damage on the clamping face that could impair proper sealing with the gasket.

### BACKGROUND OF THE INVENTION

1. Technical Field

This invention relates generally to static gaskets of the type used to establish a fluid-tight seal between two members to be clamped together, such as a manifold and a cylinder head.

2. Related Art

A gasket is typically disposed between the intake manifold and the cylinder head of an internal combustion engine to provide a fluid-type seal to various media-conveying openings, including coolant passages and air-intake passages. Some engines, particularly late model engines that have been in service for awhile, may exhibit severe corrosion around the coolant passages on the cylinder head and intake manifold that is believed to stem from an unintended electric galvanic cell that is set up between the manifold and cylinder head in the presence of the engine coolant. Over time, the sealing surfaces of the manifold and/or cylinder head may be attacked and pitted, thereby impairing the ability of the gasket to maintain a fluid-type seal and often resulting in engine coolant leaking at this joint.

### SUMMARY OF THE INVENTION AND ADVANTAGES

A gasket assembly includes a static gasket having at least one media-conveying opening in combination with a shim layer that is formed separately from the static gasket that has a first clamping surface engaging the gasket and a second opposite surface facing away from the gasket. The shim includes at least one media-conveying opening aligned with media-conveying opening of the gasket. An adhesive layer is applied to the opposite of the shim, enabling the shim to be adhered to one or both surfaces of two members to be clamped together. As such, two shims may be employed in the case where both surfaces are to be covered with the shim. The shim(s), in effect, overlies all or part of the surface or surfaces of the two members to be clamped together, providing a fresh sealing surface against which the gasket can seal.

The invention has particular advantage in connection with intake gasket applications where the clamping surface of the intake manifold and/or cylinder head has been pitted from corrosion. The damaged clamping surface(s) may be covered up by application of the shim(s) which presents a fresh sealing surface for the gasket. According, one or both damaged surfaces of a cylinder head and manifold gasket can be repaired by application of the shim layer over the damaged surface.

One advantage of the invention is that it provides a simple, low-cost solution to repairing damaged sealing surface without having to replace the components to be clamped, thereby greatly reducing the cost of repairs, particularly in the aftermarket.

A further advantage includes its usefulness in applications where the gap to be sealed is greater than the effective operational width of the gasket that is to be used. In such cases, the shim can be applied to one or both of the surfaces of the members to be clamped to decrease the effective size of the gap and thereby enable a thinner gasket to be used then would otherwise be possible. In this way, a single gasket can be used with one or more shims such that the same gasket can be used in a number of different sealing applications that would otherwise call for multiple gasket of different thickness.

According to another aspect to the invention, athe shim may be one which is made of a middle layer having upper and lower clamping surfaces and at least one opening through the layer and with a thickness of no greater than about 0.005 inches and with an adhesive applied to only one of the upper and lower surfaces. The shim layer may have the shape of all or only a part of the standard gasket to be used in sealing the two components to be clamped together.

### THE DRAWINGS

These and other features and advantages of the present invention will become more readily appreciated when considered in connection with the following detailed description and appended drawings, wherein:

FIG. 1 is an exploded fragmentary sectional view of a gasket assembly constructed according to a presently preferred embodiment of the invention;

FIG. 2 is a view like figure one but shown in the fully installed condition;

FIG. 3 is a view like figure one but incorporating an additional shim layer; and

FIGS. 4 and 5 are plan views of two representative shim layer configurations.

### DETAILED DESCRIPTION

A gasket assembly according to an embodiment of the invention is shown generally at 10 in the drawings and includes at least one gasket layer 12 and at least one accompanying shim layer 14.

The gasket layer 12 may be any of a number of types of gaskets known to the sealing art for use in providing a static seal between first and second members 16, 18 to be clamped together, such as a cylinder head in a block or manifold. The gasket layer 12 may be formed with at least one fluid-conveying opening 20 that aligns with the fluid-conveying passages 22, 24 of the first and second members 16, 18, respectively. The gasket layer 12 is operative to encircle the fluid-conveying passages 22, 24 to provide a fluid-type seal across mating clamping faces 26, 28 of the first and second members 16, 18, respectively.

The gasket layer 12 may be fabricated of any of a number of materials suitable for the particular application, such as one or more layers of steel. The gasket may have one or more elastically compressible sealing beads 30 surrounding the opening 20 which deform elastically when the gasket is clamped between the members 14, 16. While a single layer metal gasket layer 12 is illustrated in the drawings multi-layer metal gaskets are the type well known in the gasket industry, as well as other types of gaskets such as those having a metal or plastic carrier to which elastic sealing beads may be molded to one or both sides the carrier may be employed and are contemplated by the invention. As such, it is to be understood that the term “gasket layer” is to be taken in a very general sense and to include within its meaning any gasket that is designed to be clamped between two members to provide a seal at the joint for one or more media-conveying passages communicating across the joint and through the gasket.

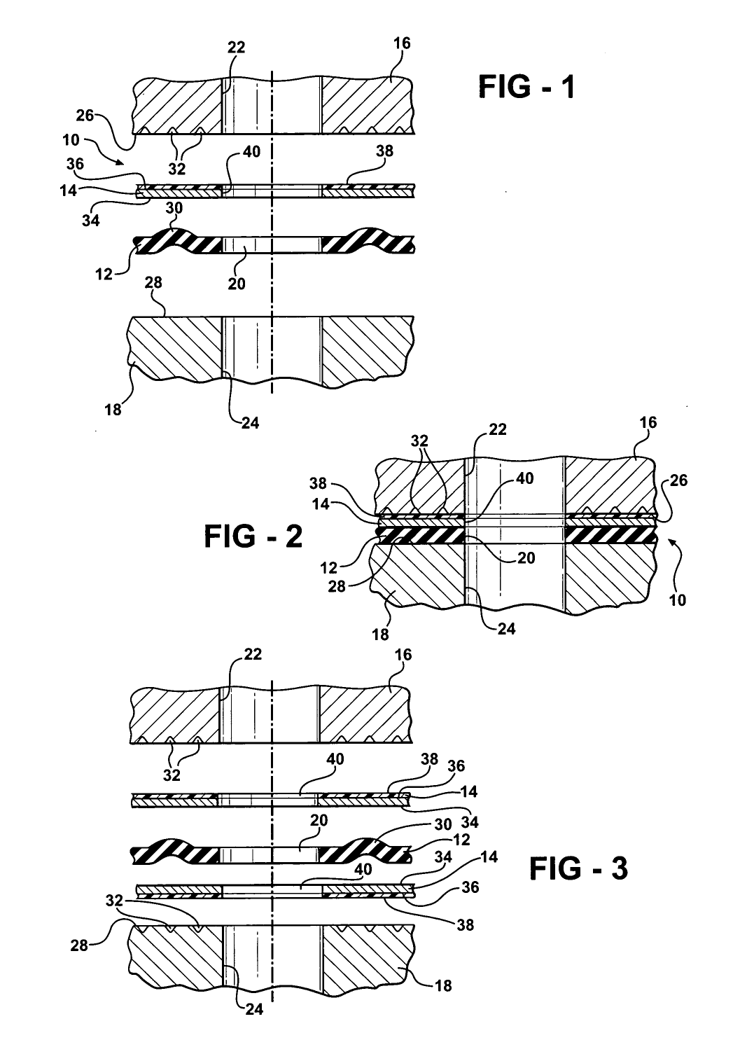

FIG. 1 illustrates a condition in which one of the members, in this case the first member 16, has a clamping face 26 that is in some way damaged so as to possibly jeopardize the ability to form a fluid-type seal with the gasket layer 12 alone when the gasket layer 12 is clamped against the damaged clamping face 26. The damage is schematically illustrated at 32 as pits in the clamping face 26 which may develop, for example, in an environment where a fluid transported through the passages 22 is one that is corrosive or reactive with the material of the first and/or second members 16, 18 alone or in the presence of the gasket layer 12. For example, a fluid such as engine coolant may react across the joint to set up an undesirable corrosion cell that may produce electro-galvanic corrosion at the joint and result in damage to one or both clamping faces 26, 28 in the form of pitting or the like as illustrated.

The shim layer 14 can be applied over all or only a part of the clamping face or faces 26, 28. The shim layer 14, in effect, covers up the damage 32 and presents a fresh, undamaged clamping face 34 of the shim layer 14 against which the gasket layer 12 can seal when clamped between the first and second members 16, 18. The shim layer 14 is formed separately from the gasket layer 12 preferably out of a thin metallic sheet of steel or the like. For example, the shim layer 14 may be fabricated of stainless steel or any other grade of steel that may be desired for a particular application.

A back surface 36 of shim layer 14 opposite of that of the clamping face 34 is provided within an adhesive layer 38 to enable the shim layer 14 to be adhered to the selected clamping face 26, 28 of the first or second member 26, 18. The shim layer 14 is formed with at least one to passage opening 40 corresponding to at least one opening 20 of the gasket layer 12.

FIG. 2 shows the shim layer 14 adhered to the clamping face 26 of the first member 16, with the opening 20 aligned with the passage 22 of the first member and covering the damaged region 32 of the clamping face 26. The gasket layer 12 is arranged between the shim layer 14 and the clamping face 28 of the second member 18, after which the first and second members 16, 18 are clamped together. It will be seen that despite the presence of the damaged 32 on the clamping face 26, the gasket layer 12 nonetheless has a damaged-free clamping face 34 of the shim layer 14 to seal against, thereby restoring the ability to provide an effective seal between the first and second members without having to replace or resurface the 1 member 16.

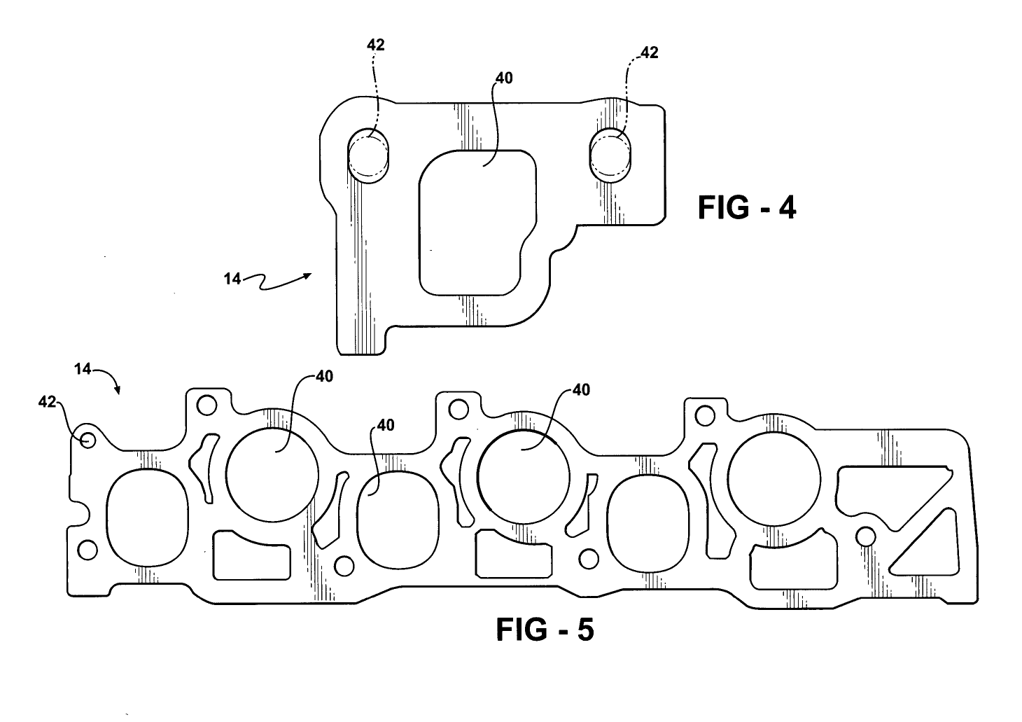

FIG. 3 illustrates an arrangement similar to that of FIGS. 1 and 2, but where two shim layers 14 are employed. It will be seen that there is damage 32 to the clamping faces 26, 28 of the first and second members 16, 18. When the shim layers 14 are applied to the first and second members 16, 18, the damage 32 is covered in a manner illustrated in FIG. 2 to provide the gasket layer 12 with fresh, undamaged clamping faces 34 of the shim layers 14 against which to seal.

Where the shim layer or layers 14 are to be used for repairing a damaged clamping face (e.g., in after-market repair of a cylinder head or a manifold surface, for example) and where a standard-sized gasket layer is to be reinstalled after the repair, then it may be desirable to have the shim layer 14 as thin as possible in order to minimize the difference in the gap with before and after the repair in which the gasket layer 12 is to be clamped. In other words, the shim layer 12 should act as a very thin skin to cover up the damage region of the clamping face without significantly altering the distance between the clamping faces 26 of the first and second member 16, 18 in the assembled condition. For this purpose, the shim layer 14 preferably has a thickness no greater than about 0.005 inches, in the adhesive layer as preferably thinner than that of the shim layer.

The invention contemplates that the shim layer 14 can be used also to effectively vary the gap between the clamping faces 26, 28 of the first and second members to the degree desired. For example, five different engines may call for a similar gasket, but having different thicknesses or multiple layers to account for a variation in the gap between the members to be joined when they are assembled. By employing a shim layer 14 according to the invention, it would be feasible to use the same the gasket for all applications and vary only the thickness of the shim layer selected to make up for the difference in gap among the applications. This may be very beneficial in an aftermarket environment in order to enable dealerships and retailers of the gaskets to decrease their inventory of different gasket part numbers and have on hand the appropriate thickness of shim layers that they can match up with the gasket for each application. Another advantage is that the shim layers will be far less expensive to produce than would be a variety of different gaskets. As such, gasket kits or assemblies may be supplied containing a selected gasket and one or more shim layers suitable for each particular application.

FIGS. 4 and 5 illustrate embodiments of two different shim layers 14 that may be employed. It will be appreciated that these are just two examples and that the shim layer could take on whatever configuration is needed to achieve the purpose of covering the damaged region of a clamping face and/or controlling the effective gap between two members to be clamped together in conjunction with a gasket layer.

The shim layer of FIG. 4 includes a single media-conveying opening 40 and two adjacent holes 42 to accommodate fasteners. The shim layer 14 of FIG. 5 contains a number of media-conveying openings 40, some of which may correspond to air-take passages between an intake manifold and a cylinder head and others corresponding to engine coolant passages as well as adjacent bolt holes.

Obviously, many modifications and variations of the present invention are possible in light of the above teachings. It is, therefore, to be understood that within the scope of the appended claims, the invention may be practiced otherwise than as specifically described.

What is claimed is:

1. A gasket shim for use with a static gasket comprising:
a metal layer having opposite upper and lower clamping surface and at least one opening through said layer;
said layer having a thickness no greater than about 0.005 inches; and
an adhesive applied to one of said upper and lower surfaces.

2. The shim of claim 1 wherein said layer includes a plurality of openings at least one of which is a media-conveying opening.

3. The shim of claim 1 said adhesive is thinner than said metal layer.

4. The shim of claim 1 wherein said metal layer has a general gasket, shape corresponding to that of the static gasket for which it is to be used.

5. A gasket assembly, comprising a static gasket having at least one media-conveying opening;
at least one shim layer formed separately from said static gasket having a first clamping surface engaging said static gasket and a second opposite surface and at least one media-conveying opening aligned with said at least one media conveying opening of said static gasket; and
an adhesive layer applied to said opposite surface.

6. The assembly of claim 6 wherein said shim layer includes a plurality of openings.

7. The assembly of claim 5 wherein said adhesive is spaced from said static gasket.

8. A method of sealing a gap between opposing clamping surfaces of two members to be sealed, comprising;
adhering a shim layer to at least one of the clamping surfaces;
positioning a gasket over at least one shim layer and clamping the members together.

10. The method of claim 8 including limiting the thickness of the shim layer to 0.005 inches or less.

11. The method of 8 including aligning media-conveying openings of the shim layer and gasket with associated openings of the members to be sealed.

12. The method of claim 8 including adhering a shim layer to the other clamping surface such that the gasket layer is positioned and clamped between the two shim layers adhered to the clamping surfaces of the two members to be sealed.
